(19) United States
(12) Patent Application Publication
(10) Pub. No.: US 2013/0120931 A1
(43) Pub. Date: May 16, 2013

(54) ENCLOSING ARRANGEMENT OF RACKS IN A DATACENTER

(71) Applicants: Sriram Sankar, Redmond, WA (US); Harry Rogers, Bellevue, WA (US); Kushagra V. Vaid, Sammamish, WA (US); Mark Shaw, Sammamish, WA (US); Bryan David Kelly, Redmond, WA (US); Grant Cowan Emerson, Kenmore, WA (US)

(72) Inventors: Sriram Sankar, Redmond, WA (US); Harry Rogers, Bellevue, WA (US); Kushagra V. Vaid, Sammamish, WA (US); Mark Shaw, Sammamish, WA (US); Bryan David Kelly, Redmond, WA (US); Grant Cowan Emerson, Kenmore, WA (US)

(73) Assignee: MICROSOFT CORPORATION, Redmond, WA (US)

(21) Appl. No.: 13/295,034

(22) Filed: Nov. 11, 2011

(51) Int. Cl. G06F 1/20; B23P 11/00; G06F 1/16

(52) U.S. Cl. 361/679.48; 361/679.02; 361/679.46; 29/428

(57) ABSTRACT

Enclosing arrangements of racks of computing devices fully encloses a space, either solely by the racks themselves, or in conjunction with structural features, such as walls and doors. The enclosed space can be either a hot aisle, whose hot air is vented out by fans positioned in at least one vertical extremity of the enclosed space, such as the floor, or ceiling, or it can be a cold aisle, whose cold air is pumped in by those fans. To maintain proper pressurization across a vertical cross-section of the enclosed space, specific ones of the computing devices have their fans adjusted based on their vertical position within the racks or have passive airflow adjustments, such as impedance screens. Computing devices can draw or vent air from their sides, taking advantage of the interstitial space between the racks provided by the enclosing arrangement.

### BACKGROUND

The throughput of communications, between multiple computing devices, that are transmitted via network connections continues to increase. For example, modern networking hardware enables physically separate computing devices to communicate with one another orders of magnitude faster than was possible with prior generations of networking hardware. Furthermore, high-speed network communication capabilities are being made available to a greater number of people, both in the locations where people work, and in their homes. As a result, an increasing amount of data and services can be meaningfully provided via such network communications. For example, audio and video entertainment can now be stored in a single, centralized location and accessed by multiple individuals “on-demand” by streaming such content, via network communications, from the centralized location to the computing devices utilized by those multiple individuals at their respective locations. Similarly, a greater variety of services can be provided over network communications including, for example, services that were traditionally executed locally on individual computing devices.

To provide such data and services, via network communications, from a centralized location, the centralized location typically comprises hundreds or thousands of computing devices, typically mounted in vertically oriented racks. Such a collection of computing devices, as well as the associated hardware necessary to support such computing devices, and the physical structure that houses the computing devices and associated hardware, is traditionally referred to as a “datacenter”. With the increasing availability of high-speed network communication capabilities, and thus the increasing provision of data and services from centralized locations, as well as the traditional utilizations of datacenters, such as the provision of advanced computing services and massive amounts of computing processing capability, the size and quantity of datacenters continues to increase.

Data centers often consume large quantities of electrical power, both to power the computing devices and associated hardware, as well as to provide environmental control, most notably cooling capability, to the computing devices. The processors and other hardware components of a computing device generate heat as part of their normal operation and, when such heat generation is multiplied across the myriad of such processors and hardware components that are present in the computing devices of the data center, the amount of heat that can be generated within the data center can be significant. Traditionally, computing devices in a data center are mounted in vertically oriented racks of such computing devices which are then aligned into rows with aisles between them. Typically, the rows of the racks of computing devices are oriented such that the backs of the computing devices of one row face the backs of the computing devices of another row. Most computing devices are cooled via airflow over the processing components, and other components that need cooling, which airflow is then directed out the back of the computing device. Consequently, by orienting the racks of the computing devices into rows where the backs of the computing devices face each other, the aisle between them becomes a “hot aisle” into which the heat produced by the processing components of those computing devices is exhausted. By contrast, the aisle between the rows of racks of computing devices into which the front and sides of those computing devices faces becomes a “cold aisle” from which air is drawn through the computing devices to be exhausted into the “hot aisle”.

### SUMMARY

In one embodiment, racks of computing devices can be oriented in an “enclosing” arrangement in which their arrangement fully encloses a space. The space can be fully enclosed by the edges of the racks themselves or it can be fully enclosed by the edges of the racks themselves in combination with structural features of the data center including, for example, a wall, a door, or combinations thereof. The enclosing racks can be arranged such that the fully enclosed space is the hot aisle, with the air vented from the computing devices of the racks being directed into the fully enclosed space, or the enclosing racks can be arranged such that the fully enclosed space is the cold aisle, with the air utilized to cool the computing devices of the racks being drawn from the cold aisle.

In another embodiment, one or more fans, or other air moving equipment, can be oriented at the top, bottom, or both vertical ends of the fully enclosed space. Because the space is fully enclosed, a reduced number of fans can be utilized to draw air through the computing devices of the racks, thereby cooling them. The computing devices themselves can be actively cooled, such as by having their own fans, or can be passively cooled strictly by the movement of air facilitated by the fans, or other air moving equipment, oriented at the vertical ends of the fully enclosed space. To maintain proper air pressure throughout the fully enclosed space the fans of individual computing devices, which are positioned at different heights in the racks, can be individually varied or other airflow controls can be provided on the individual computing devices, such as, for example, impedance screens.

In a further embodiment, the enclosing arrangement of the racks enables shorter cabling runs between the racks. Cables between the racks can be routed into established cable “raceways” that can be oriented around the periphery of the enclosed space, such as for an orientation of the computing devices where the connections are made on the sides of the computing devices that face inward into the enclosed space, or the established cable raceways can be oriented around the periphery of the rack, such as for an orientation of the computing devices where the connections are made on the sides of the computing devices that face outward away from the enclosed space.

In a still further embodiment, computing devices that are to be positioned in the racks that are arranged in an enclosing manner can be designed to draw air from the sides of those computing devices, thereby avoiding having to draw air across removable devices that are typically positioned at the front of computing devices and which can limit the flow of air into the computing devices when such air is drawn from the front. By drawing air from the sides of the computing devices the airflow can more directly pass over those processing components that most need cooling and can exit, in the traditional manner, out of the back of the computing device. The enclosing arrangement of the racks provides for interstitial space between the racks, thereby facilitating the side-cooling of computing devices positioned within those racks. Alternatively, or in addition, the interstitial space can also be utilized for cabling, with such cables being connected to those sides of the computing devices facing tangentially to the enclosed space.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary enclosing arrangement of racks of computing devices;

FIG. 2 is a block diagram of further exemplary enclosing arrangements of racks of computing devices;

FIG. 3 is a block diagram of still further exemplary enclosing arrangement of racks of computing devices;

FIG. 4 is a block diagram of an exemplary positioning of multiple enclosing arrangements of racks of computing devices within a datacenter;

FIG. 5 is a block diagram of exemplary positionings of cable raceways associated with enclosing arrangements of racks of computing devices; and

FIG. 6 is a block diagram of an exemplary side-cooled computing device for use in enclosing arrangements of racks of computing devices.

### DETAILED DESCRIPTION

The following description relates to an enclosing arrangement of racks of computing devices, such as would commonly be found in a datacenter or any other like facility. The enclosing arrangement of racks fully encloses a space, either solely by the racks themselves, or in conjunction with structural features of the datacenter, such as walls and doors. The computing devices in the racks can be oriented to either vent exhaust air, which has already been utilized to cool relevant computing components and is, therefore, hot, into the enclosed space or, conversely, the computing devices in the racks can be oriented to draw air from the enclosed space, which air, since it has not yet been utilized to cool computing components is, therefore, cold. One or more fans can be positioned at the vertical extremities of the enclosed space, such as in the floor, in the ceiling, or combinations thereof, to either draw hot air out of the enclosed space or to pump cold air into the enclosed space. Individual computing devices positioned in the enclosing arrangement of racks can have their own fans, or can be passively cooled by the fans at the vertical extremities of the enclosed space which can draw air through the computing devices, thereby cooling the relevant computing components. To maintain proper pressurization across a vertical cross-section of the enclosed space, specific ones of the computing devices can have their fans adjusted based on their vertical position within the racks or can have passive airflow adjustments added, such as, for example, impedance screens. The enclosing arrangement of racks can provide for shorter cabling runs between individual ones of the computing devices in the racks, thereby decreasing communication delays and the cost associated with such cabling, such as by enabling the use of less-expensive lower-power cables and interfaces. The cables can be grouped into “raceways” which can travel around the outside periphery of the enclosed space or the outside periphery of the enclosing arrangement of racks. Additionally, computing devices can be designed to either draw or vent air from their sides to provide more efficient cooling of computing components inside of those computing devices since an enclosing arrangement of racks provides for interstitial space between the racks from which such air can be drawn or into which such air can be vented.

For purposes of illustration, the techniques described herein make reference to existing and known facilities, such as datacenters, within which the described techniques can be utilized. Such references, however, are strictly exemplary and are not intended to limit the mechanisms described to the specific examples provided. For example, the enclosing arrangement of racks described can be utilized in any facility or context in which multiple computing devices are co-located. Similarly, for purposes of providing concrete examples to elucidate the descriptions provided, the illustrations referenced herein specifically identify a “cold aisle” and a “hot aisle” which comprise, respectively, cold air to be utilized to cool computing components and hot air that has already been utilized to cool computing components. Such references, however, are strictly exemplary and are not intended to limit the mechanisms described to the specific examples provided. Instead, any area labeled as a “hot aisle” can likewise be utilized as a “cold aisle”, and vice versa, merely by reorienting the computing devices or reversing the airflow through the computing devices.

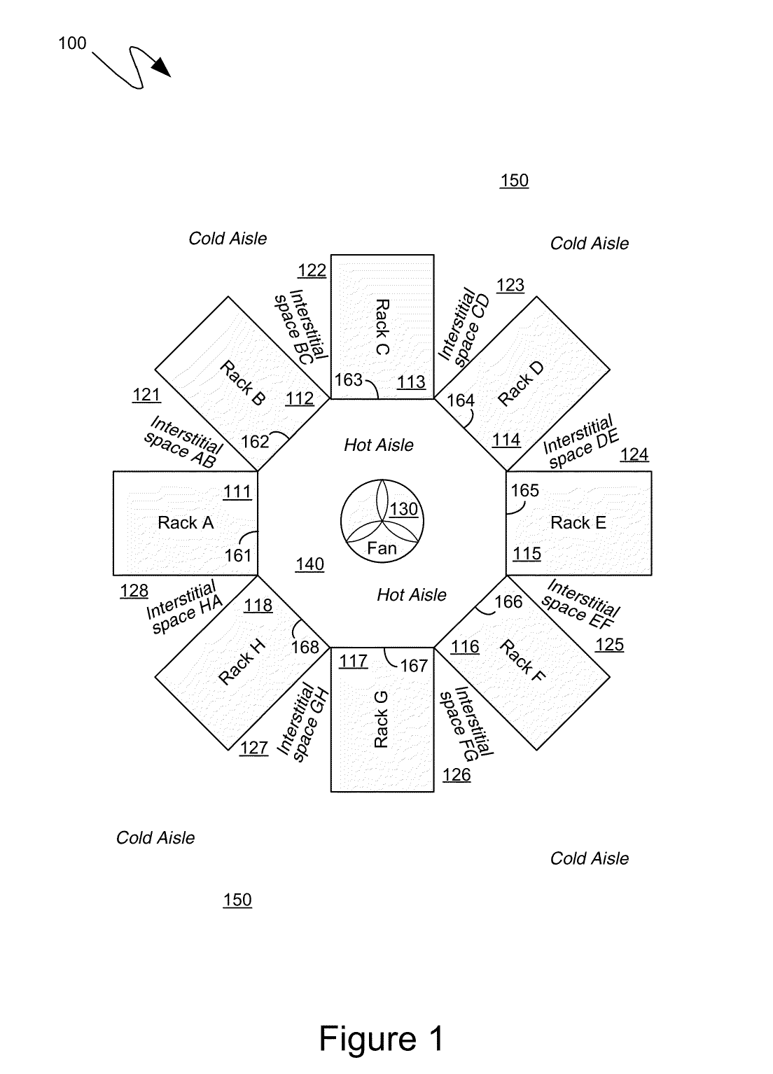

Turning to FIG. 1, an exemplary enclosing arrangement 100 of racks of computing devices is shown. More specifically, the enclosing arrangement 100 comprises a series of racks, such as the racks 111, 112, 113, 114, 115, 116, 117 and 118. In the exemplary enclosing arrangement 100 that is shown in FIG. 1, the racks of computing devices 111, 112, 113, 114, 115, 116, 117 and 118 are arranged in an enclosing manner to fully enclose a space 140 that is exemplarily labeled as the “hot aisle”. Conversely, therefore, the space outside of the enclosing arrangement of the racks 111, 112, 113, 114, 115, 116, 117 and 118, namely the space 150, is exemplarily labeled as the “cold aisle”. Thus, in the embodiment illustrated by the enclosing arrangement 100 of FIG. 1, the computing devices in the racks 111, 112, 113, 114, 115, 116, 117 and 118 are oriented such that they draw air from the cold aisle 150 to cool their computing components and then vent such air into the hot aisle 140. As indicated previously, however, the computing devices in the racks 111, 112, 113, 114, 115, 116, 117 and 118 could equally be oriented in an opposite direction, thereby causing the enclosed space 140 to be the “cold aisle” and the space 150 to be the “hot aisle”.

The enclosing arrangement 100 shown in FIG. 1 encloses the space 140 because the edges 161, 162, 163, 164, 165, 166, 167 and 168 of the racks 111, 112, 113, 114, 115, 116, 117 and 118, respectively, enclose the space 140. Thus, as utilized herein, the term “enclosing arrangement” means an arrangement in which physical items are positioned such that at least one set of edges of those physical items, either by themselves, or in combination with other structures, encloses a space.

In one embodiment, one or more fans, such as the fan 130, can be installed in the vertical extremities of the enclosed space 140, such as in the ceiling above the enclosed space 140, which represents the top of the enclosed space 140, the floor below the enclosed space 140, which represents the bottom of the enclosed space 140, or combinations thereof. For example, if the enclosed space is the hot aisle, then one or more fans, such as the fan 130, can be installed in the ceiling above the enclosed space 140 to vent out the hot air in the enclosed space 140. As another example, if the enclosed space is the cold aisle, then one or more fans, such as the fan 130, can be installed in the floor below the closed space 140 to draw in cooled air. A single fan 130 is illustrated in FIG. 1 since, as will be recognized by those skilled in the art, one large fan can be more efficient at moving the same volume of air as multiple smaller fans. Nevertheless, other embodiments contemplate the use of multiple fans instead of the single fan 130 that is shown in FIG. 1. The positioning of the individual fans in such multiple fan arrangements can be optimized through known airflow modeling and simulation techniques.

The fan 130 can, in one embodiment, provide sufficient air movement that the individual computing devices in the racks 111, 112, 113, 114, 115, 116, 117 and 118 need not utilize their own fans to draw air across the various computing components that require cooling. For example, in the embodiment illustrated in FIG. 1, where the enclosed space 140 is the hot aisle, the fan 130 can draw air from the cold aisle 150 through the computing devices of the racks 111, 112, 113, 114, 115, 116, 117 and 118 into the hot aisle 140, thereby cooling the components of those computing devices as the air passes across them, and the fan 130 can then vent the hot air from the enclosed space 140, such as into an exhaust air system located above the ceiling of the enclosed space 140. In another embodiment, however, the fans of the individual computing devices can be utilized to aid the fan 130 in moving air across the computing components of those computing devices that require cooling.

The racks of computing devices, such as the racks 111, 112, 113, 114, 115, 116, 117 and 118, can be several feet high, often reaching close to the ceiling of the space in which those racks are positioned. Consequently, in one embodiment, the air movement through individual computing devices in the racks 111, 112, 113, 114, 115, 116, 117 and 118 can be individually controlled to provide a desirable air pressure throughout the vertical column of air in the enclosed space 140. For example, if the enclosed space 140 was the hot aisle, with the fan 130 mounted in the ceiling above the enclosed space 140 and drawing air out from the enclosed space 140, then individual computing devices positioned near the top of the racks 111, 112, 113, 114, 115, 116, 117 and 118 need not operate their own fans as intensively, while the individual computing devices positioned near the bottom of the racks 111, 112, 113, 114, 115, 116, 117 and 118 may need to operate their own fans at a higher rate of speed. Alternatively, utilizing the same example, the individual computing devices positioned near the top of the racks 111, 112, 113, 114, 115, 116, 117 and 118 can have impedance screens installed to restrict the airflow in to, or out of, such computing devices, while the individual computing devices positioned near the bottom of the racks 111, 112, 113, 114, 115, 116, 117 and 118 can have no such impedance screens installed. As will be recognized by those skilled in the art, in another embodiment, where the enclosed space 140 is the cold aisle, and the fan 130 pushes cold air into the enclosed space 140, the above examples can be reversed.

In another embodiment, air can be mixed between the enclosed space 140 and the space 150 outside of the enclosing arrangement 100. For example, if the enclosed space 140 is the hot aisle, then air from the hot aisle 140 can be returned into the cold aisle 150 to be subsequently cooled and re-drawn through the computing devices of the racks of the enclosing arrangement 100. In such an embodiment, the fan 130 can represent a “mixing chamber” or other like device that can be installed near the top of the racks of the enclosing arrangement 100. As will be recognized by those skilled in the art, such a mixing chamber can also operate if the enclosed space 140 is the cold aisle, and the space 150 outside of the enclosing arrangement 100 is the hot aisle.

Traditionally, racks of computing devices, such as the racks 111, 112, 113, 114, 115, 116, 117 and 118, are square or rectangular in nature, having approximately 90 degree angles at their edges. Consequently, once such racks of computing devices are oriented in an enclosing arrangement, such as the enclosing arrangement 100 shown in FIG. 1, an approximately triangular interstitial space can be created between the racks of computing devices. For example, as shown in FIG. 1, the interstitial space 121, which is approximately triangular nature, can exist between the rack 111 and the rack 112, given how those racks are oriented in the enclosing arrangement 100. Similarly, an interstitial space 122 can exist between the rack 112 and the rack 113, and the interstitial spaces 123, 124, 125, 126, 127 and 128 can, analogously, exist between the racks 113, 114, 115, 116, 117, 118 and 111, respectively, as shown in FIG. 1. The presence of such interstitial spaces can provide for additional cooling capability, or additional cable routing capability, as will be described in further detail below.

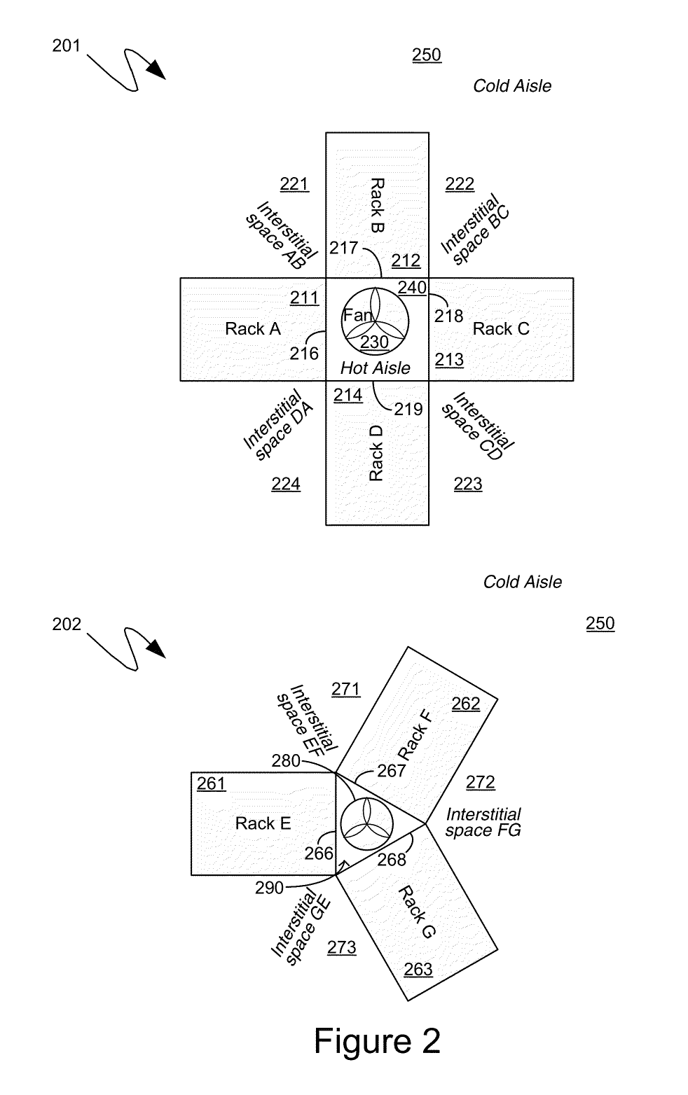

Turning to FIG. 2 two additional enclosing arrangements, namely the enclosing arrangements 201 and 202, are illustrated for purposes of showing other contemplated enclosing arrangements. In the enclosing arrangement 201, for example, the racks of computing devices 211, 212, 213 and 214 can be arranged at approximately cross-like pattern. As can be seen, the edges 216, 217, 218 and 219 of the racks 211, 212, 213 and 214, respectively, enclose the space 240, which, exemplarily, is labeled the “hot aisle”. The enclosing arrangement 201 also provides for interstitial spaces 221, 222, 223 and 224 between the racks 211 and 212, 212 and 213, 213 and 214 and, 214 and 211, respectively. As before, one or more fans 230 can be positioned at vertical extremities of the enclosed space 240 to provide air movement into, or out of the enclosed space 240. Similarly, as another example, the enclosing arrangement 202 illustrates three racks of computing devices, namely the racks 261, 262 and 263, whose edges, namely the edges 266, 267 and 268, respectively, enclose the space 290. Again, one or more fans 280 can be positioned at vertical extremities of the enclosed space 290. Additionally, interstitial spaces 271, 272 and 273 can exist between the racks.

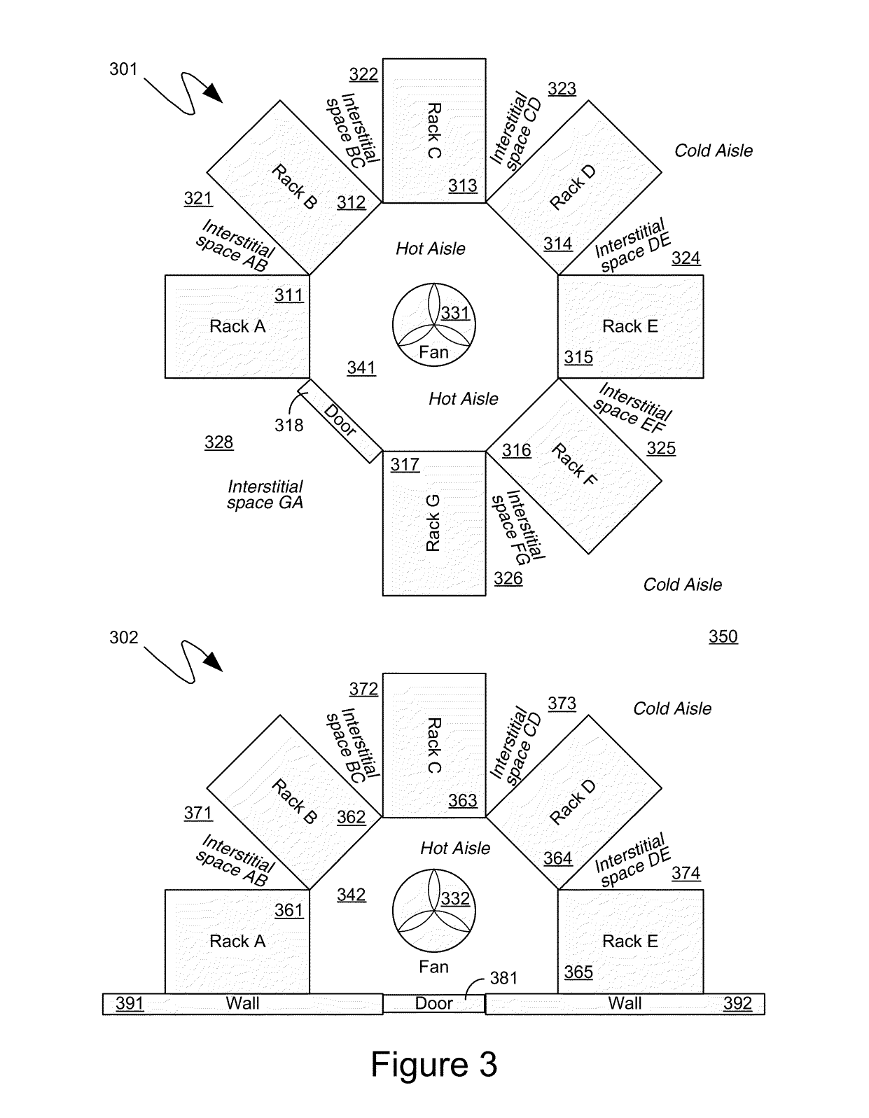

Thus, as can be seen, an enclosing arrangement can be generated from at least three racks of computing devices or at least two racks of computing devices and at least one other additional structural element, such as a structural element of the data center within which these racks of computing devices are positioned. Turning to FIG. 3, two additional enclosing arrangements, namely the enclosing arrangements 301 and 302, are illustrated for purposes of showing other enclosing arrangements that are also contemplated. In particular, both of the exemplary enclosing arrangements 301 and 302 enclose the space utilizing both racks of computing devices and at least one other structural element, such as a door, a wall, or other like structural elements. For example, the enclosing arrangement 301 comprises racks of computing devices 311, 312, 313, 314, 315, 316 and 317 and also comprises a door that spans between the racks 317 and 311 such that the space 341 is fully enclosed by the edges of the racks 311, 312, 313, 314, 315, 316 and 317 and the door 318. As will be recognized by those skilled in the art, the presence of the door 318 can provide for easy access to the enclosed space 341 which, as will be described in further detail below, can comprise connections or other like serviceable aspects of the computing devices that are arranged in the racks 311, 312, 313, 314, 315, 316 and 317. The enclosing arrangement 301 also provides for the above-mentioned interstitial space between the racks, such as the illustrated interstitial spaces 321, 322, 323, 324, 325, 326 and 328.

Another exemplary enclosing arrangement 302 is also shown in FIG. 3, where the space 342 that is enclosed by the enclosing arrangement 302 is enclosed by the racks 361, 362, 363, 364 and 365 and by a wall that can be comprised of wall segments 391 and 392 and that can optionally have a door 381 mounted therein. The enclosing arrangement 302 also provides for interstitial spaces between the racks, such as the interstitial spaces 371, 372, 373 and 374, but may not necessarily provide for interstitial spaces between the racks and structural features such as, for example, the walls 391 and 392. As before, the enclosed spaces, namely spaces 341 and 342, can have fans positioned at the vertical extremities of such spaces, namely the fans 331 and 332 that are illustrated in FIG. 3.

As can be seen from the previously described Figures, at least three racks of computing devices, or at least two racks of computing devices and at least one structural element, can be arranged in an enclosing arrangement that can enclose the space that can act as either a hot aisle or a cold aisle, and that can have one or more fans positioned in at least one vertical extremity of such an enclosed space, such as in the floor or ceiling. In one embodiment, a threshold number of computing racks can be reached, beyond which the space enclosed by an enclosing arrangement of that many computing racks can simply become too large to maintain adequate, or proper, air pressure within the enclosed space. For example, if the enclosed space represents a hot aisle, then the air pressure within such a hot aisle can be such that the cold aisle outside of the enclosing arrangement has a higher air pressure to facilitate the movement of air across computing components that require cooling. Additionally, the air pressure within such a hot aisle can be maintained such that any variances in a vertical cross-section of such a hot aisle can be addressed through individual control of the fans, or other active air movement components, of individual computing devices positioned at different vertical levels in the racks, or can be addressed through individual, passive air movement components, such as impedance screens, which can be applied to the individual computing devices positioned at different vertical levels in the racks. In one embodiment, such impedance screens can be applied to either the intake vents, exhaust vents, or combinations thereof. Similarly, as another example, if the enclosed space represents a cold aisle, then the air pressure within such a cold aisle can be greater than the air pressure of the hot aisle outside of the enclosing arrangement to, again, facilitate the movement of air across computing components that require cooling.

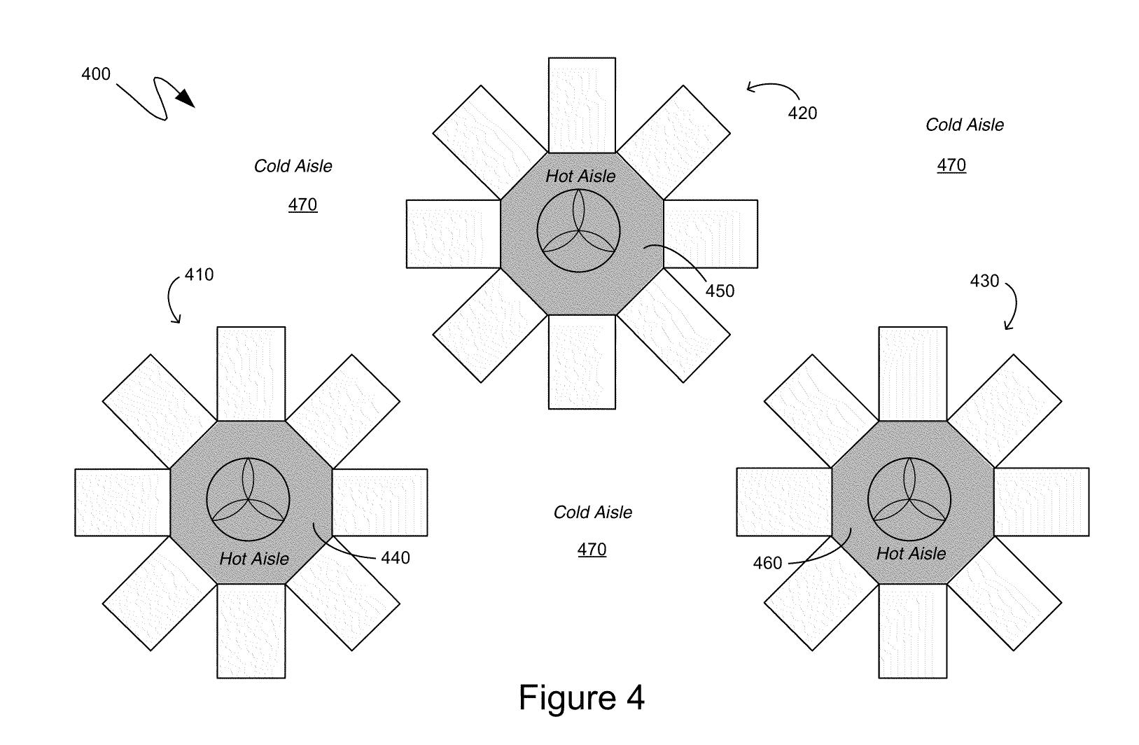

Turning to FIG. 4, the system 400 shown therein illustrates multiple enclosing arrangements, such as the enclosing arrangements 410, 420 and 430 that can be positioned within a larger structure, such as a datacenter, or any other like facility. In one embodiment, the enclosing arrangements 410, 420 and 430 can enclose spaces 440, 450 and 460, respectively, that can act as the hot aisles, and the space 470 that is outside of the enclosing arrangements 410, 420 and 430 can be a cold aisle, thereby increasing the amount of space within the datacenter that is cooler and, therefore, more comfortable for humans, and limiting the amount of space within the datacenter that is a hot aisle and contains air that may be uncomfortably warm for humans. As can also be seen from the system 400 of FIG. 4, enclosing arrangements, such as the enclosing arrangements 410, 420 and 430 can be positioned to minimize the distances between them, thereby decreasing the length of cabling from any one computing device in one rack in a datacenter to another computing device in another rack in the same datacenter. Such shorter cables can, as will be recognized by those skilled in the art, be both less expensive and can provide for more efficient communications between computing devices in the datacenter.

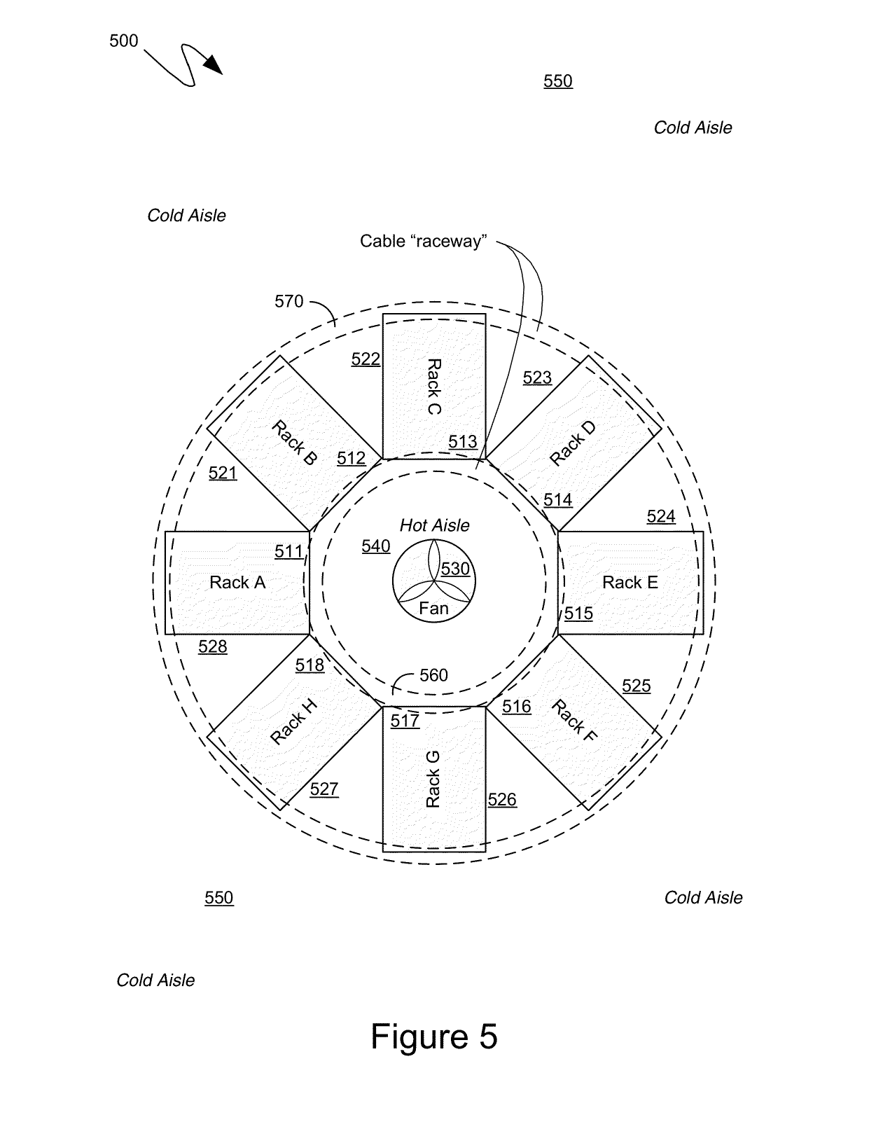

Turning to FIG. 5, an enclosing arrangement 500 is shown comprising a cable raceway that can optionally be positioned in the manner shown by the cable raceway 560 or in the manner shown by the cable raceway 570. As indicated previously, one advantage to an enclosing arrangement of racks of computing devices can be that the distances between the computing devices can be decreased as far as cable connections between the computing devices are concerned. In one embodiment, the computing devices can be positioned in the racks of the enclosing arrangement 500, such as the racks 511, 512, 513, 514, 515, 516, 517 and 518, so that the side of the computing devices on which the connectors for cables are located can be oriented to face inward into the enclosed space 540. In such an embodiment, the cables can be routed vertically along the side of the racks 511, 512, 513, 514, 515, 516, 517 and 518 that faces the enclosed space 540 until a cable raceway 560 is reached, which can be positioned at any of a number of vertical heights such as, for example, at arm height, or above head height. Once the cable raceway 560 is reached, the cables can be routed along the cable raceway 560 until they reach a different rack containing the computing device to which the cables are to be connected, at which point the cabling can leave the cable raceway 560 and can again proceed vertically up or down that rack until it reaches the location of the computing device to which such cabling is to be connected.

Alternatively, in another embodiment, the computing devices can be positioned in the racks of the enclosing arrangement 500 such that the side of the computing devices on which the connectors for cables are located can be oriented to face outward away from the enclosed space 540 and into the space 550. In such an alternative embodiment, the cables can, again, be routed vertically along the side of the racks 511, 512, 513, 514, 515, 516, 517 and 518 that faces outward into the space 550 until they reach a cable raceway 570. Again, as with the cable raceway 560, the cable raceway 570 can be positioned at any number of vertical heights including, for example, the same vertical height as is traditionally used by other cable raceways in the data center in which the enclosing arrangement 500 is located. The cables can then be routed along the cable raceway 570 until they reach a rack containing the computing device to which those cables are to be connected, at which point they can travel vertically along that rack until they reach the location of the computing device itself.

In another embodiment, not specifically illustrated in FIG. 5, rather than being routed along cable raceways, such as the cable raceway that can optionally be positioned as a cable raceway 560 or a cable raceway 570, the cables interconnecting the computing devices of the racks 511, 512, 513, 514, 515, 516, 517 and 518 of the enclosing arrangement 500, can instead create a mesh of cables across the enclosed space 540, thereby traveling directly from one computing device in the racks of the enclosing arrangement 500 to another computing device in another of the racks of the enclosing arrangement 500. More specifically, the computing devices can be oriented in the racks 511, 512, 513, 514, 515, 516, 517 and 518 of the enclosing arrangement 500 such that the side of those computing devices that comprises the connectors for cables can be oriented to face inward into the enclosed space 540. Cable connections from one computing device to another computing device can travel directly between the computing devices, across the enclosed space 540, thereby generating the above described mesh. Since subsequent maintenance on such a mesh of cables can be difficult, and said such a mesh of cables can impede airflow, in an alternative embodiment, cables between computing devices can be routed along the periphery of the enclosed space 540, but need not be constrained vertically, such that a resulting mesh is aligned approximately with the edges of the racks that form the outer boundary of the enclosed space 540.

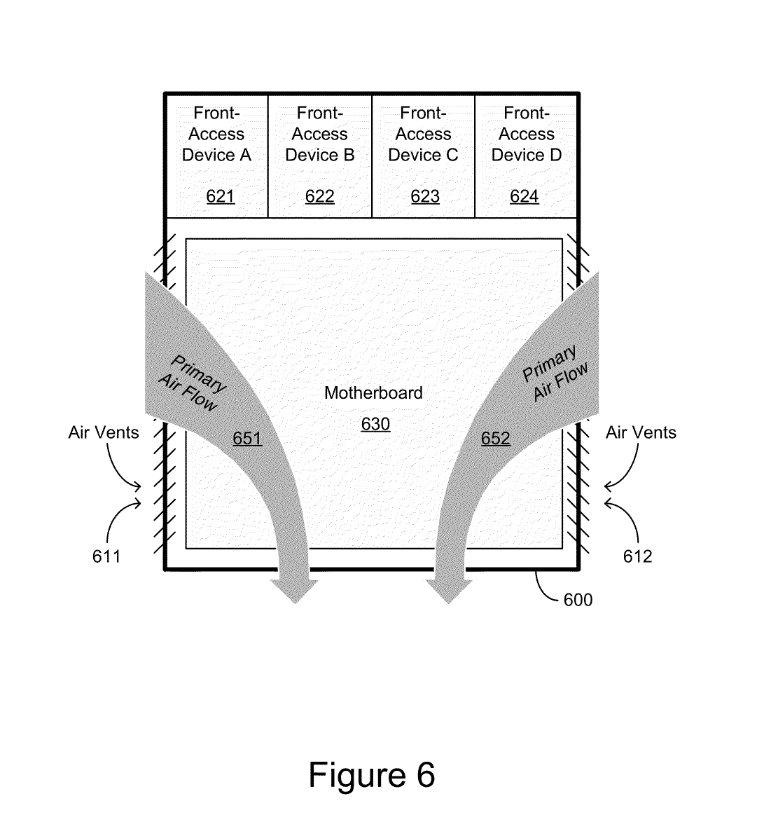

Turning to FIG. 6, an alternative design for a computing device 600 is illustrated that can take advantage of the interstitial space between the racks of computing devices in an enclosing arrangement, such as the enclosing arrangements described in detail above. More specifically, and as will be recognized by those skilled in the art, traditional computing devices that are rack-mounted typically comprise front access devices, such as the front access devices 621, 622, 623 and 624 that are illustrated in FIG. 6. Typically such front access devices comprise hard drives or other like storage devices that are designed to be accessible and easily removable from computing devices while those computing devices remain rack-mounted. Behind such front access devices, rack-mounted computing devices typically comprise a motherboard, such as the motherboard 630, which can comprise one or more computing components, such as processors, that require cooling. The motherboard typically comprises connectors that can be accessed from the back of the computing device.

Traditional cooling of such a computing device requires drawing air past the front access devices and across the computing components of the motherboard 630 that require cooling, and then venting such air out the back of the computing device. Such traditional cooling is implemented because, as indicated previously, racks of computing devices are traditionally aligned in rows such that there is no interstitial space between the sides of the racks of computing devices. However, as indicated previously, in enclosing arrangements, such as the enclosing arrangements described in detail above, interstitial space exists between the sides of the racks of the computing devices such that a computing device can draw air from that interstitial space to aid in cooling.

In one embodiment, such as that illustrated by the computing device 600 of FIG. 6, the computing device 600 can comprise air vents 611 and 612 on the side of the computing device. Consequently, the computing device 600 can generate airflow, such as the primary airflow 651 and 652, that can, primarily, be drawn in from the sides of the computing device 600 directly across the motherboard 630, thereby cooling the components of that motherboard more directly, and thus more efficiently and more effectively. As will be recognized by those skilled in the art, even in the arrangement shown in FIG. 6, at least some airflow will be drawn from the front of the computing device 600, since the front access devices 621, 622, 623 and 624 do not, likely, perfectly seal off the front of the computing device and, as such, provide at least a marginal pathway for air. Nevertheless, the primary airflow 651 and 652 can drawn in through the computing device 600 from the side, such as through the side air vents 612 and 612, respectively, and then be vented out of the back of the computing device 600 in a traditional manner. Consequently, the computing components of the motherboard 630 can be cooled more directly than they would be by airflow drawn in, in the more traditional manner, past the front access devices. And while the primary airflow 651 and 652 is shown as being drawn in from the sides of the computing device 600, via the air vent 611 and 612, and being exhausted out the back of the computing device 600, an alternative embodiment contemplates that the primary airflow 651 and 652 can move in the opposite direction, whereby it can be drawn from the back of the computing device 600 and vented out the side of the computing device 600, such as via the air vents 611 and 612.

Because the primary airflow 651 and 652 is not impeded by the front access devices 621, 622, 623 and 624, a reduced amount of fans, or reduced fan energy, can be utilized while still maintaining adequate cooling of the computing components on the motherboard 630. Similarly, because the primary airflow 651 and 652 is not drawn from the front of the computing device and across the front access devices 621, 622, 623 and 624, it is not pre-heated by those devices, which, as will be recognized by those skilled in the art, also can generate heat. As a result, the primary airflow 651 and 652 allows for cooler air to reach the motherboard 630, thereby further making such cooling more efficient. Additionally, because of such unobstructed airflow, the pressure drop between the hot aisle and the cold aisle can be lessened. As yet another benefit, by drawing, or venting, air from the sides of the computing device, such as via the air vents 611 and 612, a greater quantity of components can be positioned on the motherboard 630 within a direct airflow path. Consequently, the placement of components need not be as critical, since a greater quantity of components can receive more efficient cooling, while the density of the components on the motherboard 630 need not change. The placement of components on a motherboard, such as the motherboard 630, that can have the benefit of side cooling can also enable such components to be more easily accessible, such as for maintenance or replacement. For example, the air vents 611 and 612 can be removable, hinged, or otherwise able to provide access to the interior of the computing device 600 from its sides. Consequently, in such an embodiment, the front access devices 621, 622, 623 and 624 can be easily and efficiently serviced from the front of the computing device 600, while the motherboard 630, and associated components, or components located proximate thereto, can be easily and efficiently services from the sides of the computing device 600.

In one embodiment, only some computing devices within a rack of computing devices can be designed in the manner of the computing device 600 of FIG. 6, with side ventilation, while other computing devices can maintain traditional front-to-back ventilation. In such an embodiment, front-to-back ventilation computing devices can be interleaved within the rack of computing devices with side-to-back ventilation computing devices, thereby reducing the amount of computing devices “fighting” for cool air from any given space.

In another embodiment, in addition to the air vents 611 and 612, or instead of, the computing device 600 can further comprise connectors located on its sides such that cabling can be routed vertically along the sides of a rack of computing devices, thereby utilizing the interstitial space between racks of computing devices, which are arranged in an enclosing arrangement, for cabling. In such an embodiment, a cable raceway, such as those illustrated in FIG. 5, can be positioned somewhere in between the cable raceway positions 560 and 570 that were shown in FIG. 5, such that cabling can leave the raceway and proceed vertically along the sides of the racks.

As can be seen from the above descriptions, enclosing arrangements of racks of computing devices have been enumerated. In view of the many possible variations of the subject matter described herein, we claim as our invention all such embodiments as may come within the scope of the following claims and equivalents thereto.

We claim:

1. At least two enclosing arrangements of racks of computing devices, the at least two enclosing arrangements being positioned adjacent to one another and each enclosing a space separate and apart from spaces enclosed by others of the at least two enclosing arrangements, and each of the at least two enclosing arrangements individually comprising either at least three racks of computing devices arranged to fully enclose a space and to create triangular interstitial space between the racks, or at least two racks of computing devices and at least one structural element of a facility hosing the at least two enclosing arrangements, the at least two racks of computing devices and the at least one structural element being arranged to fully enclose a space and to create triangular interstitial space between the racks.

2. The at least two enclosing arrangements of claim 1, wherein the at least one structural element comprises a door providing access into the enclosed space.

3. The at least two enclosing arrangements of claim 1, wherein the at least one structural element comprises a wall.

4. The at least two enclosing arrangements of claim 1, wherein the computing devices in the racks are oriented such that exhaust air from the computing devices, that was used to cool computing components of those computing devices, is exhausted into the enclosed space.

5. The at least two enclosing arrangements of claim 1, further comprising at least one fan, for each of the at least two enclosing arrangements, positioned at a vertical extremity of the enclosed space.

6. The at least two enclosing arrangements of claim 5, wherein the computing devices on the racks are fan-less computing devices that are cooled by air moved through the computing devices by the at least one fan.

7. The at least two enclosing arrangements of claim 5, wherein airflow control components, that control airflow through individual ones of the computing devices on the racks, are adjusted based on a vertical position, in the racks, of the individual ones of the computing devices.

8. The at least two enclosing arrangements of claim 7, wherein the airflow control components comprise impedance screens that are installed on at least some of the individual ones of the computing devices based on their vertical positions in the racks.

9. The at least two enclosing arrangements of claim 1, further comprising at least one cable raceway, for at least one of the at least two enclosing arrangements, that is concentric to the enclosed space enclosed by the at least one enclosing arrangement.

10. The at least two enclosing arrangements of claim 1, further comprising at least one mesh of cables, for at least one of the at least two enclosing arrangements, that is constrained along sides of the enclosed space that is enclosed by the at least one enclosing arrangement.

11. The at least two enclosing arrangements of claim 1, comprising at least one side-venting computing device that utilizes the interstitial space between the racks to cool computing components of the at least one side-venting computing device.

12. The at least two enclosing arrangements of claim 11, comprising multiple side-venting computing devices that are interleaved, in the racks, with front/back venting computing devices.

13. A method for arranging racks of computing devices comprising the steps of: creating at least two enclosing arrangements of racks of computing devices, the at least two enclosing arrangements being positioned adjacent to one another and each enclosing a space separate and apart from spaces enclosed by others of the at least two enclosing arrangements, and each of the at least two enclosing arrangements individually comprising either at least three racks of computing devices arranged to fully enclose a space and to create triangular interstitial space between the racks, or at least two racks of computing devices and at least one structural element of a facility hosing the at least two enclosing arrangements, the at least two racks of computing devices and the at least one structural element being arranged to fully enclose a space and to create triangular interstitial space between the racks.

14. The method of claim 13, further comprising the steps of: orienting the computing devices in the racks such that exhaust air from the computing devices, that was used to cool computing components of those computing devices, is exhausted into the enclosed space.

15. The method of claim 13, further comprising the steps of: individually adjusting airflow control components, that control airflow through individual ones of the computing devices on the racks, based on a vertical position, in the racks, of the individual ones of the computing devices.

16. The method of claim 15, wherein the step of individually adjusting airflow control components comprises installing impedance screens on at least some of the individual ones of the computing devices based on their vertical positions in the racks.

17. The method of claim 13, wherein the computing devices comprise at least one side-venting computing device that utilizes the interstitial space between the racks to cool computing components of the at least one side-venting computing device.

18. The method of claim 17, further comprising the step of installing computing devices in the racks, such that side-venting computing devices are interleaved, in the racks, with front/back venting computing devices.

19. A computing device comprising:
a front side without air vents;
a back side opposite the front side, the back side comprising one or more air vents;
a first side adjacent to the front side and the back side and connecting the front side with the back side;
a second side opposite the first side, the second side also being adjacent to the front side and the back side and connecting the front side with the back side;
one or more accessible devices installed proximate to the front side and accessible from the front side;
at least one motherboard comprising computing components requiring cooling, the at least one motherboard installed behind the one or more accessible devices such that the one or more accessible devices are between the front side and the computing components of the motherboard that require cooling;
and one or more air vents on both the first side and the second side providing for air movement between the first side and the back side and between the second side and the back side.

20. The computing device of claim 19, wherein the computing components requiring cooling are positioned on the motherboard to be within a first direct airflow path between the one or more vents on the first side and the one or more vents on the back side or to be within a second direct airflow path between the one or more vents on the second side and the one or more vents on the back side.
